(19) United States
(12) Patent Application Publication
(10) Pub. No.: US 2021/0222410 A1
(43) Pub. Date: Jul. 22, 2021

(54) WATER OUTLET ASSEMBLY, WATER OUTLET DEVICE, AND KITCHEN FAUCET

(71) Applicant: Xiamen Solex High-Tech Industries Co., Ltd., Xiamen (CN)

(72) Inventors: Shilong WU, Xiamen (CN); Fengde LIN, Xiamen (CN); Donghai CHEN, Xiamen (CN); Bin CAO, Xiamen (CN)

(21) Appl. No.: 17/150,315

(22) Filed: Jan. 15, 2021

(30) Foreign Application Priority Data
Jan. 16, 2020 (CN) 202010046969.8

(51) Int. Cl. E03C 1/086

(52) U.S. Cl. CPC E03C 1/086

(57) ABSTRACT

The present disclosure discloses a water outlet assembly and a water outlet assembly. The water outlet assembly comprises an ejector and a water outlet portion. The ejector and the water outlet portion are disposed along a water flow direction. The ejector comprises a jet hole. The water outlet portion comprises a shielding portion and a water outlet hole penetrating the shielding portion. An opening of the water outlet hole is enlarged along the water flow direction. Water ejected from the jet hole is divided into an impact portion and a straight portion, the impact portion impacts the shielding portion and flows out along an edge of the water outlet hole to define a water curtain, and the straight portion directly flows through the water outlet hole to be ejected to define straight water.

### RELATED APPLICATIONS

This application claims priority to Chinese patent application number 202010046969.8, filed Jan. 16, 2020. Chinese patent application number 202010046969.8 is incorporated herein by reference.

### FIELD OF THE DISCLOSURE

The present disclosure relates to the technical fields of kitchen and bathroom faucets, and in particular relates to a water outlet assembly and a water outlet device.

### BACKGROUND OF THE DISCLOSURE

There are numerous types of existing water outlet devices. By way of example, a first type of water outlet device comprises an ejector, and the ejector comprises a jet hole. The water ejected from the jet hole defines straight water, and the straight water has great impact force. A second type of water outlet device comprises a water outlet plate, and the water outlet plate comprises a water outlet hole. Water flowing through the second type of water outlet device impacts the water outlet plate, flows out along a periphery of the water outlet hole, and defines a water curtain. The above-mentioned two types of water outlet devices each only has a single spray pattern, and there is a need for further improvement.

### BRIEF SUMMARY OF THE DISCLOSURE

The present disclosure provides a water outlet assembly and a water outlet device to solve the deficiencies of the water outlet device in the background.

In order to solve the technical problems, a first technical solution of the present disclosure is as follows.

A water outlet assembly comprises an ejector and a water outlet portion. The ejector and the water outlet portion are disposed along a water flow direction. The ejector comprises a jet hole. The water outlet portion comprises a shielding portion and a water outlet hole penetrating the shielding portion. An opening of the water outlet hole is enlarged along the water flow direction. Water ejected from the jet hole is divided into an impact portion and a straight portion, the impact portion impacts the shielding portion and flows out along an edge of the water outlet hole to define a water curtain, and the straight portion directly flows through the water outlet hole to be ejected to define straight water.

In an embodiment, a cross-section of the jet hole comprises a concave area extending outward or a corner area.

In an embodiment, a cross-section of the jet hole defines a plum blossom shape.

In an embodiment, the ejector comprises a through hole, an inner wall of the through hole is convex to define one or more ribs, the through hole defines the jet hole due to the one or more ribs, and the jet hole defines a plum blossom shape structure.

In an embodiment, the opening of the water outlet hole defines a tapered structure with a large lower large end and a small upper end.

In an embodiment, the water outlet hole comprises an upper section and a lower section disposed along the water flow direction. An upper end port of the water outlet hole extends downward to define the upper section, a lower peripheral edge of the upper section expands and extends downward and outward to define the lower section, and the lower section defines the tapered structure.

In an embodiment, the water outlet hole comprises a central area overlapped by the jet hole in a top-down projection and a remaining area not overlapped by the jet hole in the top-down projection, the straight portion corresponds to the central area, and the remaining area half encompasses the central area to generate a water curtain to define the water curtain disposed in an outer circle and half encompassing the straight water disposed in an inner circle.

In an embodiment, the impact portion impacts the shielding portion and flows downward along an edge of the remaining area of the water outlet hole.

In an embodiment, the edge of the remaining area comprises an arc section, and the impact portion impacts the shielding portion and flows downward at least along the arc section.

In an embodiment, an upper end port of the water outlet hole comprises a substantially W-shaped structure.

In an embodiment, a middle top portion of the substantially W-shaped structure define a central area, and the straight portion directly flows through the central area of the water outlet hole to be ejected.

In an embodiment, the substantially W-shaped structure comprises the central area and a remaining area, and the remaining area half encompasses the central area.

In an embodiment, a plurality of connecting lines are connected together to define a peripheral edge of the upper end port of the water outlet hole, and connection points of the plurality of connecting lines are smoothly disposed.

In an embodiment, a periphery of an upper end port of the water outlet hole comprises a V-shaped section, two curved sections axially symmetrically disposed on two sides of the V-shaped section, and a circular arc section, first ends of the two curved sections are connected to two ends of the V-shaped section, the two curved sections and the V-shaped section cooperate to define a substantially W-shaped structure, two ends of the circular arc section are respectively connected to second ends of the two curved sections, an opening of the circular arc section is disposed opposite to a top angle of the V-shaped section, a portion encompassed by the V-shaped section defines a central area, and the straight portion corresponds to the central area.

In an embodiment, the impact portion flows out along the two curved sections or the two curved sections and the circular arc section.

In an embodiment, the water outlet portion comprises a plurality of water outlet holes, including the water outlet hole, the jet hole corresponds to the plurality of water outlet holes, the plurality of water outlet holes are disposed in an annular array, and an axis of the annular array coincides with an axis of the jet hole.

In an embodiment, upper end ports of the plurality of water outlet holes comprise substantially W-shaped structures, and middle top portions of the W-shaped structures face the axis of the annular array.

In an embodiment, a periphery of the shielding portion extends upward to define a lower peripheral wall, and the ejector is disposed in an upper port of the lower peripheral wall.

In an embodiment, the ejector comprises an upper peripheral wall, an upper portion of the upper peripheral wall extends outward to define a convex ring, a middle plate is secured in the upper peripheral wall, the middle plate comprises the jet hole, the upper peripheral wall cooperates with and is disposed in the lower peripheral wall, and the convex ring abuts an end surface of the lower peripheral wall.

In an embodiment, an outer diameter of the middle plate is smaller than a diameter of the shielding portion.

In order to solve the technical problems, a second technical solution of the present disclosure is as follows.

A water outlet assembly comprises an ejector and a water outlet portion. The ejector and the water outlet portion are disposed along a water flow direction. The ejector comprises a jet hole. A cross-section of the jet hole comprises a concave area extending outward or a corner area. The water outlet portion comprises a shielding portion and a water outlet hole penetrating the shielding portion. The water outlet hole comprises a central area overlapped by the jet hole in a top-down projection and a remaining area not overlapped by the jet hole in the top-down projection, the jet hole comprises an overlapped portion disposed on the water outlet hole in the top-down projection and a non-overlapped portion disposed on the shielding portion and an outer side of the water outlet hole in the top-down projection, and the concave area extending outward or the corner area of the jet hole corresponds to the central area of the water outlet hole.

In order to solve the technical problems, a third technical solution of the present disclosure is as follows.

A water outlet device comprises a housing portion and the water outlet assembly. The housing portion comprises an upper housing and a lower housing, the upper housing is disposed with a connector, the lower housing is secured to the upper housing, a middle cavity in communication with the connector is defined between the upper housing and the lower housing, and the water outlet assembly is secured to the lower housing.

In order to solve the technical problems, a fourth technical solution of the present disclosure is as follows.

A kitchen faucet comprises a faucet body. A water outlet port of the faucet body is disposed with the water outlet assembly.

In order to solve the technical problems, a fifth technical solution of the present disclosure is as follows.

A kitchen faucet comprises a faucet body. A water outlet port of the faucet body is disposed with the water outlet device.

Compared with the existing techniques, the technical solution has the following advantages.

The water outlet hole expands outward along the water flow direction. The impact portion of the water ejected from the jet hole impacts the shielding portion and flows out along the edge of the water outlet hole to define a water curtain. The straight portion directly flushes through the water outlet hole and flows out to be ejected to define straight water. The ejected water is divided into two portions. One portion defines the straight water to strengthen the straight impact force, and the other portion cooperates and expands to define a water curtain that can generate particle spray. The water curtain and the straight water flow out concurrently to have a good water spray effect.

The cross section of the jet hole has a concave area extending outward or a corner area. The water outlet hole has a central area overlapped by the jet hole in a top-down projection and a remaining area not overlapped by the jet hole in the top-down projection. The jet hole comprises the overlapped portion disposed on the water outlet hole in the top-down projection and the non-overlapped portion disposed on the shielding portion and an outer side the water outlet hole in the top-down projection. The concave area extending outward or the corner area of the jet hole corresponds to the center area of the water outlet hole. The ejected water is divided into two portions. One portion cooperates with the concave area extending outward or the corner area to define the straight water to improve straight impact force, and the other portion cooperates and expands to define a water curtain. The water curtain and the straight water flow out concurrently, the water spray effect is good.

The cross section of the jet hole has the concave area extending outward or the corner area to cooperate with the straight portion, and the straight impact force can be more powerful.

The through hole defines the jet hole due to the ribs, and the jet hole has a plum blossom shape, which is convenient for production and simple in structure.

### BRIEF DESCRIPTION OF THE DRAWINGS

The present disclosure will be further described below in combination with the accompanying drawings and embodiments.

FIG. 1 illustrates a front view of a water outlet device according to an embodiment.

FIG. 2 illustrates a cross-sectional view of the water outlet device according to the embodiment.

FIG. 3 illustrates an exploded perspective view of the water outlet device according to the embodiment.

FIG. 4 illustrates an exploded perspective view of a water outlet assembly of the embodiment.

FIG. 5 illustrates a perspective view of an ejector of the embodiment.

FIG. 6 illustrates a first perspective view of a water outlet portion of the embodiment.

FIG. 7 illustrates a second perspective view of the water outlet portion of the embodiment.

FIG. 8 illustrates a cross-sectional view of the water outlet assembly of the embodiment.

FIG. 9 illustrates a first water discharging view of the water outlet assembly of the embodiment.

FIG. 10 illustrates a second water discharging view of the water outlet assembly of the embodiment.

FIG. 11 illustrates a third water discharging view of the water outlet assembly of the embodiment.

FIG. 12 illustrates a top-down view of the water outlet device of the embodiment.

Reference numbers: housing portion 1, water outlet assembly 2, upper housing 11, lower housing 12, through installation hole 120, connector 111, middle cavity 13, ejector 21, through hole 210, jet hole 211, rib 212, upper peripheral wall 213, convex ring 214, middle plate 215, water outlet portion 22, shielding portion 221, water outlet hole 222, tapered structure 223, V-shaped section 224, curved section 225, circular arc section 226, central area 224′, remaining area 225′, lower peripheral wall 227, straight water 31, and half-encompassing water curtain 32.

### DETAILED DESCRIPTION OF THE EMBODIMENTS

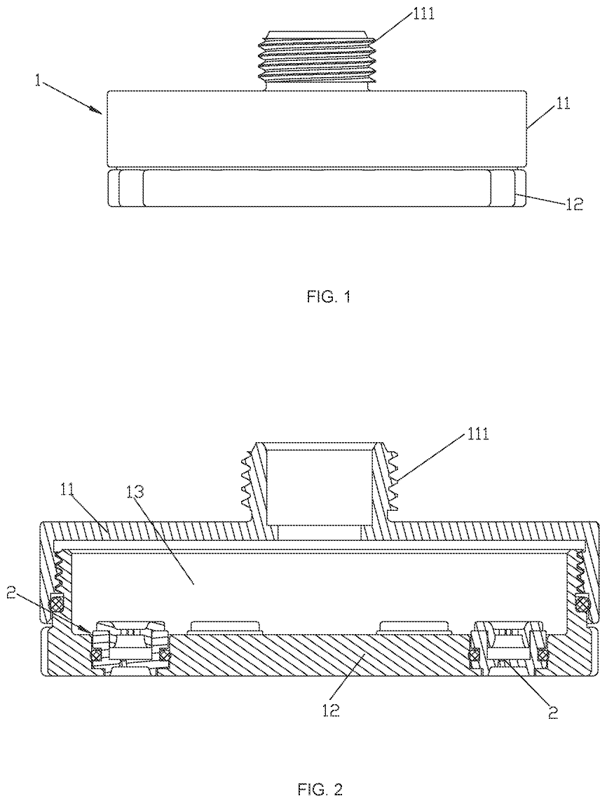

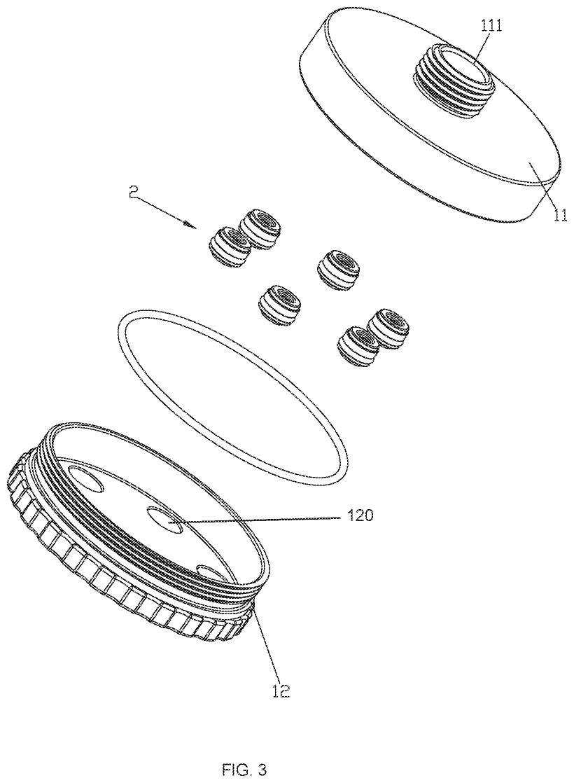

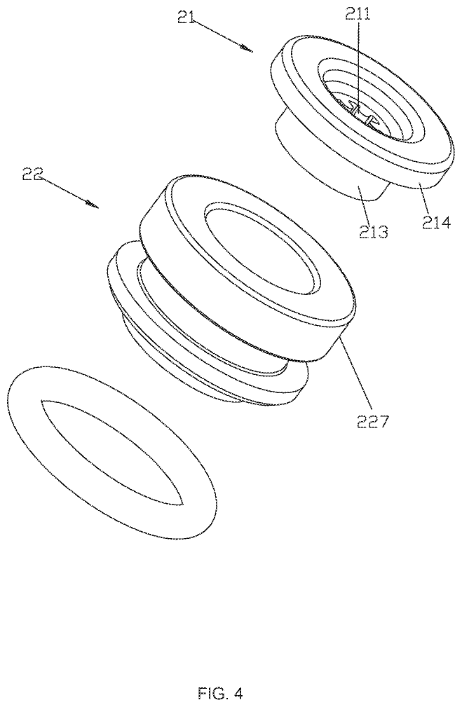

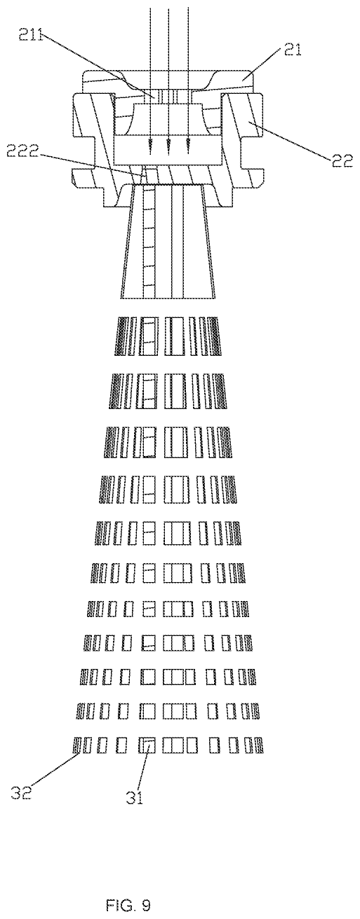

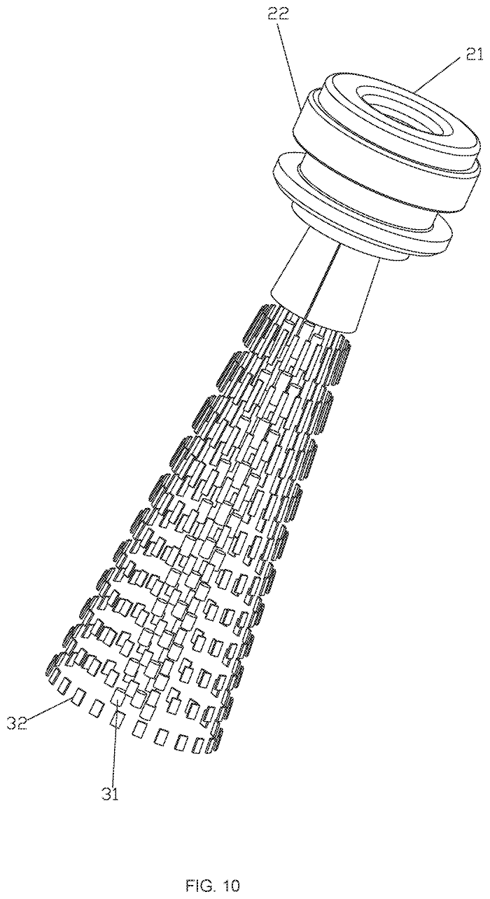

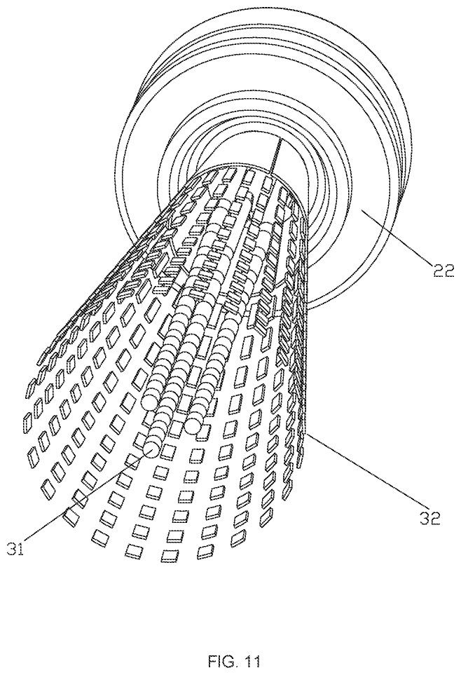

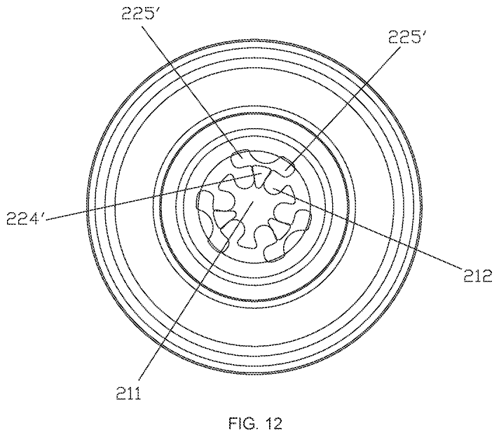

Referring to FIGS. 1-12, a water outlet device comprises a housing portion 1 and a water outlet assembly 2. The housing portion 1 comprises an upper housing 11 and a lower housing 12. The upper housing 11 is disposed with a connector 111. The lower housing 12 is secured to the upper housing 11, and a middle cavity 13 in communication with the connector 111 is defined between the upper housing 11 and the lower housing 12. The water outlet assembly 2 is secured to the lower housing 12 and is in communication with the middle cavity 13. The water outlet assembly 2 comprises an ejector 21 and a water outlet portion 22 disposed along a water flow direction.

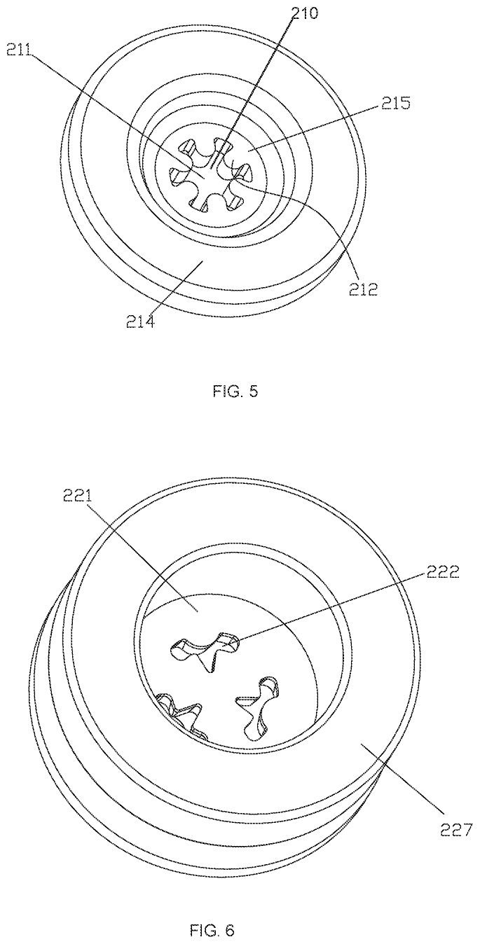

The ejector 21 comprises a jet hole 211. A cross-section of the jet hole 211 defines a non-circular shape. In some embodiments, the cross-section of the jet hole 211 defines a plum blossom shape, and a cross-section of the plum blossom shape comprises a plurality of concave areas extending outward (i.e., a corner area). Referring to FIGS. 4-5, the plurality of concave areas comprise six concave areas extending outward, but the disclosure is not limited to thereto. In some embodiments, the plurality of concave areas comprise four or five concave areas extending outward, etc. In some embodiments, the ejector 21 comprises a through hole 210, and an inner wall of the through hole 210 is convex to define one or more ribs 212. The through hole 210 defines the jet hole 211 due to the one or more ribs 212, and the jet hole 211 defines a plum blossom shape structure. The water outlet portion 22 comprises a shielding portion 221 and a water outlet hole 222 penetrating through the shielding portion 221. An opening of the water outlet hole 222 is enlarged along the water flow direction. Water ejected from the jet hole 211 is divided into an impact portion and a straight portion, and the impact portion impacts the shielding portion 221 and flows out along an edge (not a peripheral edge) of the water outlet hole 222 to define a half-encompassing water curtain 32. The straight portion directly flushes through the water outlet hole 222 to be ejected to define straight water 31. Thus, the water ejected from the water outlet hole 222 comprises the straight water 31 and the half-encompassing water curtain 32 that half encompasses the straight water 31.

In this embodiment: the opening of the water outlet hole 222 defines a tapered structure 223 with a large lower end and a small upper end. In some embodiments, the water outlet hole 222 comprises an upper section and a lower section disposed along the water flow direction. An upper end port of the water outlet hole 222 extends downward to define the upper section, a lower peripheral edge of the upper section expands and extends downward and outward to define the lower section, and the lower section defines the tapered structure 223. A peripheral edge of the upper end port of the water outlet hole 222 comprises a V-shaped section 224, two curved sections 225 axially symmetrically disposed on two sides of the V-shaped section 224, and a circular arc section 226. First ends of the two curved sections 225 are respectively connected to the two ends of the V-shaped section 224, and the two curved sections 225 and the V-shaped section 224 cooperate to define a substantially W-shaped structure. Two ends of the circular arc section 226 are respectively connected to second ends of the two curved sections 225. An opening of the circular arc section 226 is disposed opposite to a top angle of the V-shaped section 224. The two curved sections 225 are substantially circular arc-shaped sections, and a central angle of each of the substantially circular arc-shaped sections 225 is greater than 180 degrees. In some embodiments, a portion encompassed by the V-shaped section 224 defines a central area 224′, a remaining portion in the water outlet hole 222 except for the central area 224′ defines a remaining area 225′, and the remaining area 225′ half encompasses the central area 224′. In some other embodiments, a portion encompassed by the two curved sections 225 defines the remaining area 225′, a remaining portion in the water outlet hole 222 except for the remaining area 225′ defines the central area 224′, and the remaining area 225′ half encompasses the central area 224′. The straight portion corresponds to the central area 224′. The impact portion impacts the shielding portion 221 and flows out (i.e., downward) partially, totally, or breakably (i.e., in two or more distinct and separate portions) along the two curved sections 225 and/or partially, totally, or breakably along the circular arc section 226 to define the half-encompassing water curtain 32 having a shape similar to a fan. The half-encompassing water curtain 32 half encompasses the straight water 31. The half-encompassing water curtain 32 is defined by a water curtain due to the above-mentioned structure. When the half-encompassing water curtain 32 being not closed or being broken in the middle flows through the tapered structure 223, the water is finally ejected along an outer wall of the water outlet hole 222 to define a fan-shaped water spray expanding outward due to the principle of the Coanda effect. The fan-shaped water spray expands outward. Therefore, when the fan-shaped water spray expands for a certain distance, the fan-shaped water spray is broken to define particle water spray. A plurality of connecting lines are connected together to define the peripheral edge of the upper end port of the water outlet hole 222, and connection points of each of the plurality of connecting lines are smoothly disposed.

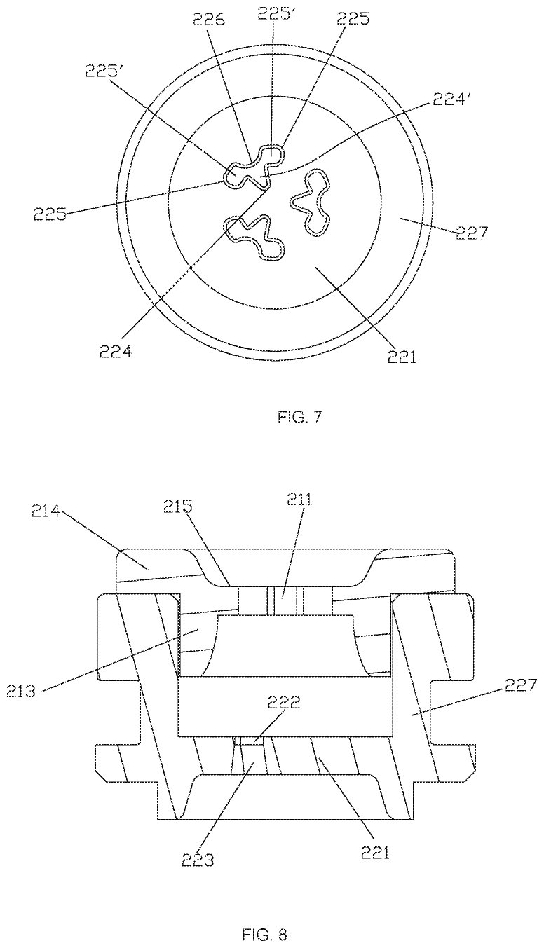

In this embodiment, the ejector 21 comprises the jet hole 211, and the water outlet portion 22 comprises a plurality of water outlet holes 222. Referring to FIGS. 6 and 7, the water outlet portion 22 comprises three water outlet holes 222, but the water outlet portion 22 is not limited thereto. The water outlet portion 22 can comprise four water outlet holes 222, five water outlet holes 222, six water outlet holes 222, etc. The jet hole 211 corresponds to the plurality of water outlet holes 222. The plurality of water outlet holes 222 are disposed in an annular array, and an axis of the annular array coincides with an axis of the jet hole 211. The top angles of the V-shaped sections 224 (i.e., middle top portions of the substantially W-shaped structures) of the plurality of water outlet holes 222 face the axis of the annular array. The plurality of water outlet holes 222 comprise the central areas 224′ overlapped by the jet hole 211 in a top-down projection, and the remaining areas 225′ do not overlap the jet hole 211 in the top-down projection. The jet hole 211 comprises an overlapped portion disposed on the plurality of water outlet holes 222 in the top-down projection and a non-overlapped portion disposed on the shielding portion 221 and an outer side of the plurality of water outlet holes 222 in the top-down projection. In this embodiment, the overlapped portion is disposed on the central areas 224′, and the non-overlapped portion defines a middle portion of the shielding portion 221, so that impacting water just flows downward along an edge of the remaining area 225′.

In this embodiment, the shielding portion 221 extends upward to define a lower peripheral wall 227. The ejector 21 comprises an upper peripheral wall 213, and an upper portion of the upper peripheral wall 213 extends outward to define a convex ring 214. A middle plate 215 is secured in the upper peripheral wall 213, and the middle plate 215 comprises the jet hole 211. The upper peripheral wall 213 cooperates with and is disposed in the lower peripheral wall 227 (i.e., an upper port of the lower peripheral wall 227), and the convex ring 214 abuts an end surface of the lower peripheral wall 227. The lower housing 12 comprises a through installation hole 120, and the lower peripheral wall 227 is secured in the through installation hole 120. An outer diameter of the middle plate 215 is smaller than a diameter of the shielding portion 221.

In this water outlet device, after the water flows into the middle cavity 13 through the upper housing 11, the water is diverted to each of the water outlet assemblies 2. The ejector 21 divides and adjusts the water into a high-speed water flow defining a plum blossom shape. Part of the high-speed water flow (the impact portion) impacts the shielding portion 221 and decelerates and then flows out along an arc-shaped outer wall of the water outlet hole 222 to define a fan-shaped water curtain (the half-encompassing water curtain 32) (i.e., the water curtain disposed in an outer circle). The other part of the high-speed water flow (the straight portion) directly passes through the central area 224′ of the water outlet hole 222 to define a water spray with stronger impact force (the straight water 31), and the water curtain disposed in the outer circle surrounds the straight water disposed in an inner circle. A single water outlet hole 222 discharges a unique water spray with both a water curtain and straight water. The water spray has a beautiful appearance and good washing effect, and the water curtain disposed in the outer circle can block water splashing due to the straight water. Moreover, a shape of the water outlet hole 222 is special, and an appearance is highly recognizable.

The aforementioned embodiments are merely some embodiments of the present disclosure, and the scope of the disclosure is not limited thereto. Thus, it is intended that the present disclosure cover any modifications and variations of the presently presented embodiments provided they are made without departing from the appended claims and the specification of the present disclosure.

What is claimed is:

1. A water outlet assembly, comprising:
an ejector, and
a water outlet portion, wherein:
the ejector and the water outlet portion are disposed along a water flow direction,
the ejector comprises a jet hole,
the water outlet portion comprises a shielding portion and a water outlet hole penetrating the shielding portion,
an opening of the water outlet hole is enlarged along the water flow direction,
water ejected from the jet hole is divided into an impact portion and a straight portion,
the impact portion impacts the shielding portion and flows out along an edge of the water outlet hole to define a water curtain, and
the straight portion directly flows through the water outlet hole to be ejected to define straight water.

2. The water outlet assembly according to claim 1, wherein a cross-section of the jet hole comprises a concave area extending outward or a corner area.

3. The water outlet assembly according to claim 1, wherein a cross-section of the jet hole defines a plum blossom shape.

4. The water outlet assembly according to claim 1, wherein:
the ejector comprises a through hole,
an inner wall of the through hole is convex to define one or more ribs,
the through hole defines the jet hole due to the one or more ribs, and
the jet hole defines a plum blossom shape structure.

5. The water outlet assembly according to claim 1, wherein:
the water outlet hole comprises a central area overlapped by the jet hole in a top-down projection and a remaining area not overlapped by the jet hole in the top-down projection,
the straight portion corresponds to the central area, and
the remaining area half encompasses the central area to generate a water curtain to define the water curtain disposed in an outer circle and half encompassing the straight water disposed in an inner circle.

6. The water outlet assembly according to claim 5, wherein the impact portion impacts the shielding portion and flows downward along an edge of the remaining area of the water outlet hole.

7. The water outlet assembly according to claim 6, wherein:
the edge of the remaining area comprises an arc section, and
the impact portion impacts the shielding portion and flows downward at least along the arc section.

8. The water outlet assembly according to claim 1, wherein:
a periphery of an upper end port of the water outlet hole comprises a V-shaped section, two curved sections axially symmetrically disposed on two sides of the V-shaped section, and a circular arc section,
first ends of the two curved sections are connected to two ends of the V-shaped section,
the two curved sections and the V-shaped section cooperate to define a substantially W-shaped structure,
two ends of the circular arc section are respectively connected to second ends of the two curved sections,
an opening of the circular arc section is disposed opposite to a top angle of the V-shaped section,
a portion encompassed by the V-shaped section defines a central area,
the straight portion corresponds to the central area, and
the impact portion flows out along the two curved sections or the two curved sections and the circular arc section.

9. The water outlet assembly according to claim 1, wherein:
the water outlet portion comprises a plurality of water outlet holes, including the water outlet hole,
the jet hole corresponds to the plurality of water outlet holes,
the plurality of water outlet holes are disposed in an annular array, and
an axis of the annular array coincides with an axis of the jet hole.

10. The water outlet assembly according to claim 9, wherein:
upper end ports of the plurality of water outlet holes comprise substantially W-shaped structures, and
middle top portions of the substantially W-shaped structures face the axis of the annular array.

11. The water outlet assembly according to claim 1, wherein:
a periphery of the shielding portion extends upward to define a lower peripheral wall, and
the ejector is disposed in an upper port of the lower peripheral wall.

12. The water outlet assembly according to claim 11, wherein:
the ejector comprises an upper peripheral wall,
an upper portion of the upper peripheral wall extends outward to define a convex ring,
a middle plate is secured in the upper peripheral wall,
the middle plate comprises the jet hole,
the upper peripheral wall cooperates with and is disposed in the lower peripheral wall, and
the convex ring abuts an end surface of the lower peripheral wall.

13. The water outlet assembly according to claim 12, wherein an outer diameter of the middle plate is smaller than a diameter of the shielding portion.

14. A water outlet assembly, comprising:
an ejector, and
a water outlet portion, wherein:
the ejector and the water outlet portion are disposed along a water flow direction,
the ejector comprises a jet hole,
a cross-section of the jet hole comprises a concave area extending outward or a corner area,
the water outlet portion comprises a shielding portion and a water outlet hole penetrating the shielding portion,
the water outlet hole comprises a central area overlapped by the jet hole in a top-down projection and a remaining area not overlapped by the jet hole in the top-down projection,
the jet hole comprises an overlapped portion disposed on the water outlet hole in the top-down projection and a non-overlapped portion disposed on the shielding portion and an outer side of the water outlet hole in the top-down projection, and
the concave area extending outward or the corner area of the jet hole corresponds to the central area of the water outlet hole.

15. A water outlet device, comprising:
a housing portion, and
the water outlet assembly according to claim 1, wherein:
the housing portion comprises an upper housing and a lower housing,
the upper housing is disposed with a connector,
the lower housing is secured to the upper housing,
a middle cavity in communication with the connector is defined between the upper housing and the lower housing, and
the water outlet assembly is secured to the lower housing.

16. The water outlet assembly according to claim 1, wherein the opening of the water outlet hole defines a tapered structure with a large lower large end and a small upper end.

17. The water outlet assembly according to claim 16, wherein:
the water outlet hole comprises an upper section and a lower section disposed along the water flow direction,
an upper end port of the water outlet hole extends downward to define the upper section,
a lower peripheral edge of the upper section expands and extends downward and outward to define the lower section, and
the lower section defines the tapered structure.

18. The water outlet assembly according to claim 1, wherein an upper end port of the water outlet hole comprises a substantially W-shaped structure.

19. The water outlet assembly according to claim 18, wherein:
a middle top portion of the substantially W-shaped structure define a central area, and
the straight portion directly flows through the central area of the water outlet hole to be ejected.

20. The water outlet assembly according to claim 18, wherein the substantially W-shaped structure comprises a central area and a remaining area, and the remaining area half encompasses the central area.
